(19) United States
(12) Patent Application Publication
(10) Pub. No.: US 2025/0175454 A1
(43) Pub. Date: May 29, 2025

(54) SELECTIVELY ENABLING VIRTUAL PRIVATE NETWORK CONNECTIONS BASED ON THE RADIO ACCESS TECHNOLOGY TYPE OF THE BEARER

(71) Applicant: AT&T Intellectual Property I, L.P., Atlanta, GA (US)

(72) Inventors: Richard Zaffino, Kirkland, WA (US); Ronak Shah, Issaquah, WA (US)

(21) Appl. No.: 18/521,117

(22) Filed: Nov. 28, 2023

(51) Int. Cl. H04L 9/40

(52) U.S. Cl. CPC H04L 63/0272; H04L 63/102; H04L 63/20

(57) ABSTRACT

One example of a method performed by a processing system of a user endpoint device in a communications network includes detecting a network traffic flow to be securely delivered from the user endpoint device to a destination in the communications network, determining that a bearer that the user endpoint device is currently utilizing to connect to the communications network is a cellular bearer, and controlling, in response to the determining, a virtual private network client of the user endpoint device to route the network traffic flow to the destination over existing network interfaces in a manner that bypasses a virtual private network connection of the user endpoint device.

The present disclosure relates generally to mobile communications networks, and relates more particularly to devices, non-transitory computer-readable media, and methods for selectively enabling virtual private network connections based on the radio access technology type of the bearer.

### BACKGROUND

A virtual private network (VPN) is a means of establishing a secure connection between a user endpoint device and a network using an insecure communication medium (e.g., the Internet). In mobile networking, a mobile user endpoint device (e.g., a mobile phone, a tablet computer, or the like) may include a VPN client that is responsible for establishing a virtual point-to-point connection to a network, using tunneling protocols. All traffic between the mobile user endpoint device and the network will then traverse this point-to-point connection.

### SUMMARY

The present disclosure broadly discloses methods, computer-readable media, and systems for selectively enabling virtual private network connections based on the radio access technology type of the bearer. In one example, a method performed by a processing system of a user endpoint device in a communications network includes detecting a network traffic flow to be securely delivered from the user endpoint device to a destination in the communications network, determining that a bearer that the user endpoint device is currently utilizing to connect to the communications network is a cellular bearer, and controlling, in response to the determining, a virtual private network client of the user endpoint device to route the network traffic flow to the destination over existing network interfaces in a manner that bypasses a virtual private network connection of the user endpoint device.

In another example, a non-transitory computer-readable medium may store instructions which, when executed by a processing system of a user endpoint device in a communications network, cause the processing system to perform operations. The operations may include detecting a network traffic flow to be securely delivered from the user endpoint device to a destination in the communications network, determining that a bearer that the user endpoint device is currently utilizing to connect to the communications network is a cellular bearer, and controlling, in response to the determining, a virtual private network client of the user endpoint device to route the network traffic flow to the destination over existing network interfaces in a manner that bypasses a virtual private network connection of the user endpoint device.

In another example, a user endpoint device in a communications service provider core network may include a processing system including at least one processor and a non-transitory computer-readable medium storing instructions which, when executed by the processing system, cause the processing system to perform operations. The operations may include detecting a network traffic flow to be securely delivered from the user endpoint device in a communications network to a destination in the communications network, determining that a bearer that the user endpoint device is currently utilizing to connect to the communications network is a cellular bearer, and controlling, in response to the determining, a virtual private network client of the user endpoint device to route the network traffic flow to the destination over existing network interfaces in a manner that bypasses a virtual private network connection of the user endpoint device.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for selectively enabling virtual private network connections based on the radio access technology type of the bearer may operate;

FIG. 2 illustrates a flowchart of an example method for selectively enabling virtual private network connections based on the radio access technology type of the bearer, in accordance with the present disclosure;

FIG. 3 illustrates a flowchart of an example method for selectively enabling virtual private network connections based on the radio access technology type of the bearer, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for selectively enabling virtual private network connections based on the radio access technology type of the bearer. As discussed above, a virtual private network (VPN) is a means of establishing a secure connection between a user endpoint device and a network using an insecure communication medium (e.g., the Internet). In mobile networking, a mobile user endpoint device (e.g., a mobile phone, a tablet computer, or the like) may include a VPN client that is responsible for establishing a virtual point-to-point connection to a network, using tunneling protocols. All traffic between the mobile user endpoint device and the network will then traverse this point-to-point connection.

Traffic that is carried over the point-to-point connection is encrypted and not visible to the network infrastructure as the traffic traverses the tunnel. This makes VPNs very attractive solutions to customers who are concerned about privacy. However, the lack of visibility into the tunneled traffic also creates challenges for mobile network service providers whose services may rely, in at least some part, on the ability to identify certain characteristics of the traffic. For instance, traffic containing certain types of data (e.g., streaming video files, sensor readings from monitored locations, or the like) or traffic traveling to or from certain endpoints (e.g., mobile devices that subscribe to services that guarantee prioritized handling), may require specific routing and/or steering over the mobile communications network. The inability to detect characteristics of tunneled traffic may therefore make it difficult for a mobile network service provider to optimize handling of the tunneled traffic. Thus, customer experience may suffer from sub-optimal performance.

Moreover, VPN treatment tends to be an all-or-nothing proposition. That is, if the VPN client on a user endpoint device has enabled a VPN connection, then all traffic traveling between the user endpoint device and the other tunnel endpoint generally travels over the VPN connection, without exception. At best, some VPN clients may potentially allow specific applications to bypass the VPN.

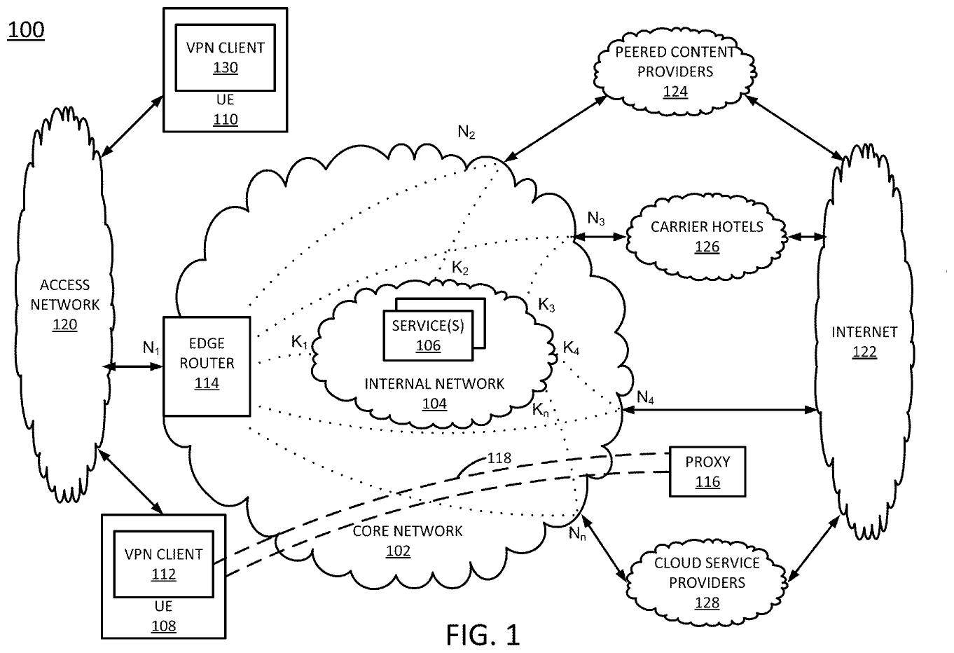

Examples of the present disclosure selectively enable or disable a VPN connection based on the type of radio access technology of the bearer that is in use. More specifically, when a user endpoint device attempts to utilize a VPN connection while connected to a cellular bearer, the VPN client may disable or bypass the VPN connection, as cellular networks inherently provide privacy that is comparable to, and may in some instances even exceed, that provided by a VPN. Bypassing the VPN connection will allow the operator of the cellular network the necessary access to characterize the network traffic for which the user endpoint device is an endpoint and to apply differentiated routing or treatment where appropriate. Thus, privacy can be provided to the user endpoint device without compromising the customer experience. When the user endpoint device attempts to utilize the VPN while connected to a non-cellular bearer (e.g., WiFi) network, the VPN client may enable or allow the VPN connection. These and other aspects of the present disclosure are discussed in greater detail below in connection with the examples of FIGS. 1-4.

To further aid in understanding the present disclosure, FIG. 1 illustrates an example system 100 in which examples of the present disclosure for providing clientless virtual private networking may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks, such as access network 120, and with the Internet 122. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include a service provider internal network 104, a plurality of edge routers, such as edge router 114, and a plurality of interfaces N₁-Nₙ (hereinafter individually referred to as a “core network interface N” or collectively referred to as “core network interfaces N”) via which the core network 102 may communicate with other networks (e.g., access network 120, specialized networks 124, 126, and 128, Internet 122, and the like). In one example, the core network interface N₁ that connects the access network 120 to the core network 102 may have connections (shown as dotted lines in FIG. 1) to all of the remaining core network interfaces N₂-Nₙ. For ease of illustration, various additional elements of the core network 102 are omitted from FIG. 1.

The internal service provider network 104 may include infrastructure for providing various internal services 106 that may affect routing of network traffic through the core network 102, such as domain name system (DNS) services, parental control services, secure browsing/cyber security services, video policy services, and/or other services. The internal service provider network 104 may further include a plurality of interfaces K₁-Kₙ (hereinafter individually referred to as an “internal network interface K” or collectively referred to as “internal network interfaces K”) via which the internal service provider network 104 may communicate with other networks (e.g., access network 120, specialized networks 124, 126, and 128, Internet 122, and the like) via the core network interfaces N. This allows the internal services 106 to access the access network 120, specialized networks 124, 126, and 128, and Internet 122.

In one example, the access network 120 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network or the like), a cellular access network, a 3^{rd} party network, or the like. For example, the operator of the core network 102 may provide a cable television service, an IPTV service, a media streaming service, or any other types of communication services to subscribers via access network 120.

In one example, the core network 102 may be operated by a communication network service provider (e.g., an Internet service provider, or a service provider who provides Internet services in addition to other communication services). The core network 102 and the access network 120 may be operated by different service providers, the same service provider or a combination thereof, or the access network 120 may be operated by an entity having core businesses that are not related to communications services, e.g., corporate, governmental, or educational institution LANs, and the like.

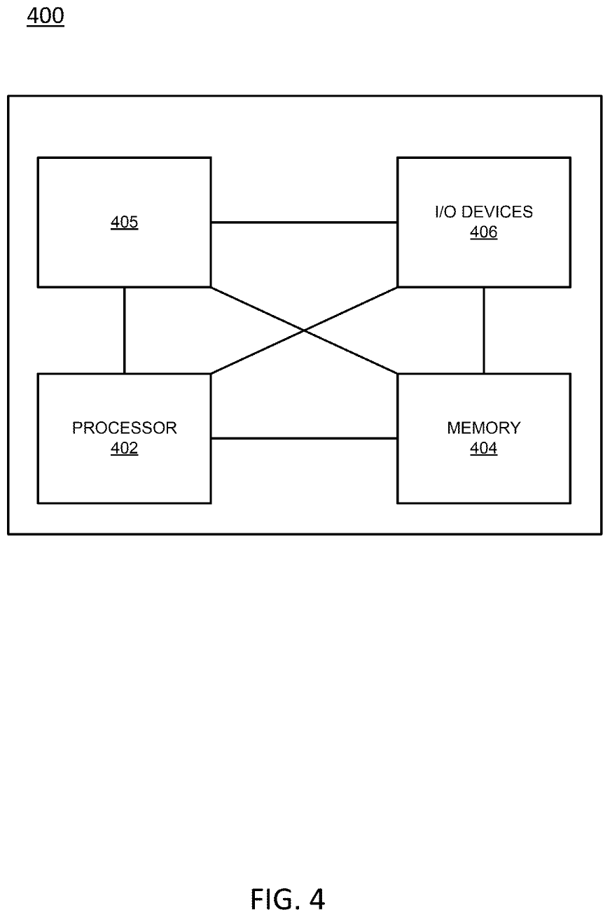

In one example, the access network 120 may be in communication with one or more user endpoint devices (UEs) 108 and 110. The access network 120 may transmit and receive communications between the user endpoint devices 108 and 110, between the user endpoint devices 108 and 110, internal network 104, the Internet 122, specialized networks such as a peer content provider network 124 (e.g., including media streaming services, such as streaming video and audio services), a carrier hotel network 126 (e.g., including large-scale data centers), a cloud service provider network 128 (e.g., including cloud computing services), other components of the core network 102, devices reachable via the Internet in general, and so forth. In one example, each of the user endpoint devices 108 and 110 may comprise any single device or combination of devices that may comprise a user endpoint device, such as computing system 400 depicted in FIG. 4, and may be configured as described below. For example, the user endpoint devices 108 and 110 may each comprise a mobile device, a cellular smart phone, a gaming console, a set top box, a laptop computer, a tablet computer, a desktop computer, an autonomous vehicle, an extended reality (XR) device, an Internet of Things (IoT) device, an application server, a bank or cluster of such devices, and the like.

Each of the UEs 108 and 110 may have a plurality of applications executing thereon. These applications may include, for example, media streaming applications (e.g., streaming video or audio), gaming applications, Web browsing applications, banking applications, navigation applications, social media applications, and the like. Some of these applications may require treatment by one or more of the internal services 106. Other applications may require that network traffic between the UE 108 or 110 and an endpoint be carried via a VPN. Thus, each UE 108 or 110 may include a VPN client, such as the example VPN client 112 of the UE 108 or the example VPN client 130 of the UE 110. The VPN client 112 or 130 may comprise a software program that establishes a VPN connection (e.g., with a VPN proxy, such as VPN proxy 116) when privacy is needed for network traffic exchanged between the UE 108 or 110 and an endpoint.

Typically, a non-VPN (but encrypted) connection from a UE 108 or 110 is made over the access network 120 to core network interface N1 and to subsequent networks or services 106 in the internal service provider network 104 (via the appropriate internal network interface K) or to connected networks (e.g., Internet 122, peered content provider network 124, carrier hotel network 126, cloud service provider network 128, or another network) via the appropriate core network interface N.

A typical VPN would establish an encrypted tunnel (such as example encrypted tunnel 118) from the UE 108 or 110 to a VPN proxy (e.g., VPN proxy 116) that is connected to the core network 102. The encrypted tunnel would isolate all traffic from the service provider internal network 104. Thus, none of the internal services 106 would be available to the UE 108 or 110 unless: (a) the traffic left the VPN proxy 116 for the Internet 122 (in general, a connection does exist between the VPN proxy 116 and the Internet 122); (b) the traffic was able to re-enter the core network 102 (e.g., via one of the core network interfaces N₂-Nₙ); or (c) the internal services 106 were available to inbound traffic at the internal network interfaces K₂-Kₙ. With respect to (c), however, it is noted that many services like the internal services 106 are only available to inbound traffic at the internal network interface K₁ that connects the service provider internal network 104 to the access network 102/core network interface N₁.

Thus, core network interfaces N₂-Nₙ and internal network interfaces K₂-Kₙ to the specialized networks 124, 126, and 128 and to the Internet 122, as well the internal network interface K₁ to the access network 120, are not accessible to traffic that is routed through the encrypted tunnel (e.g., the traffic cannot “see” these interfaces N and K). Likewise, the service provider internal network 104 cannot route traffic that is routed through the encrypted tunnel to the internal network interface K₁ for application of internal services 106 (e.g., the service provider internal network 104 cannot “see” the traffic in the encrypted tunnel).

Examples of the present disclosure may deploy a switch in the VPN client 112 or 130 of a UE 108 or 110, where the switch may be set (e.g., by a user) to selectively enable or disable a VPN connection of the UE 108 or 110 based on the type of radio access technology of the bearer that the UE 108 or 110 is using to connect to the core network 102. In one example, the switch may enable the VPN connection when the UE 108 or 110 utilizes a WiFi bearer to access the core network 102, but may disable or bypass the VPN connection when the UE 108 or 110 utilizes a cellular bearer to access the core network 102.

Typical cellular networks inherently provide a level of privacy that is comparable to, and in some instances may even exceed, that provided by a VPN. To a large extent, cellular networks are operated and managed as private networks. Cellular network operators typically implement data and user privacy policies to protect user data, and these policies often exceed policies required by regulations. Thus, from a privacy perspective, the use of a VPN on a cellular network may be redundant.

As such, limiting VPN use to non-cellular radio access technology bearers may permit cellular network operators to characterize network traffic and therefore manage the network traffic more effectively, while also providing user and data privacy. For instance, in the case of video traffic, bypassing a VPN connection on cellular bearers would allow a cellular network operator to serve subscribers in the manner intended (e.g., by avoiding the delivery of video files having bitrates that are unsupported by the subscriber's UE, subscription plan, or preferences) without sacrificing privacy.

In one example, when the VPN client 112 or 130 determines that a particular flow of network traffic from a UE 108 or 110 (which may already been encrypted) is being carried over a non-cellular bearer, the VPN client 112 or 130 may create a tunnel (e.g., tunnel 118) and route the flow of network traffic via the tunnel to the VPN proxy 116 or another endpoint. Conversely, when the VPN client 112 or 130 determines that a particular flow of network traffic from a UE 108 or 110 (which may already been encrypted) is being carried over a cellular bearer, the VPN client 112 or 130 may route these flows so that the flows bypass the tunnel 118.

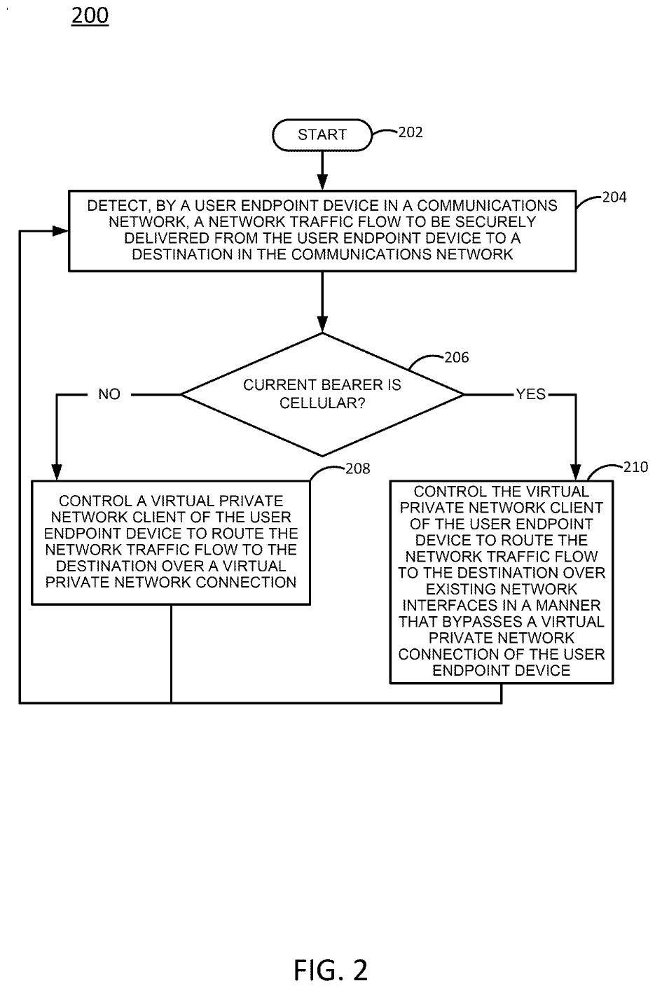

In some examples, the switch may be implemented in another client on the UE 108 or 110 other than the VPN client 112 or 130. For instance, the another client may comprise a software application executing on the UE 108 or 110, such as a stock trading application, a video streaming application, or the like. Further details of an example method for selectively enabling virtual private network connections based on the radio access technology type of the bearer by the VPN client 112 or 130 (or by another client on the UE) is described in greater detail below in connection with FIG. 2.

The VPN client 112 or 130 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In other examples, a device in the core network, such as the edge router 114 or VPN proxy 116, may implement a function that selectively allows or blocks network traffic flows via VPN connections based on the type of bearer via which the UE 108 or 110 connects to the core network 102. For instance, the edge router 114 or VPN proxy 116 may detect when an incoming network traffic flow is being routed via a VPN connection. If the UE 108 or 110 that is the source of the incoming network traffic flow is connected to the core network 102 via a cellular bearer, then the edge router 114 or VPN proxy 116 may block the incoming network traffic flow.

Optionally, the edge router 114 or VPN proxy 116 may recommend that a user of the UE 108 or 110 either change the settings of the UE 108 or 110 (or the VPN client 112 or 130 of the UE 108 or 110) to bypass VPN connections when connecting to the core network 102 via a cellular bearer or retry sending the incoming network traffic flow once connected to the core network 102 via a non-cellular bearer. However, if the UE 108 or 110 that is the source of the incoming network traffic flow is connected to the core network 102 via a non-cellular bearer, then the edge router 114 or VPN proxy 116 may allow the incoming network traffic flow to be routed to the destination via the VPN connection.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access network 120, internal network 104, specialized networks 124-128, and/or Internet 122 may comprise a content distribution network (CDN) having ingest servers, edge servers, and the like. Similarly, although only one access network 120 is shown, in other examples, the access network 120 may comprise a plurality of different access networks that may interface with the core network 102 independently or in a chained manner. For example, UE devices 108 and 110 may communicate with the core network 102 via different access networks. Thus, these and other modifications are all contemplated within the scope of the present disclosure.

FIG. 2 illustrates a flowchart of an example method 200 for selectively enabling virtual private network connections based on radio access technology, in accordance with the present disclosure. In one example, steps, functions and/or operations of the method 200 may be performed by a device as illustrated in FIG. 1, e.g., a VPN client 112 or 130 of a UE 108 or 110 (or any one or more components thereof). In another example, the steps, functions, or operations of method 200 may be performed by a computing device or system 400, and/or a processing system 402 as described in connection with FIG. 4 below. For instance, the computing device 400 may represent a VPN client of a user endpoint device in accordance with the present disclosure. For illustrative purposes, the method 200 is described in greater detail below in connection with an example performed by a processing system, such as processing system 402.

The method 200 begins in step 202. In step 204, the processing system may detect a network traffic flow to be securely delivered from a user endpoint device to a destination in a communications network.

In one example, the user endpoint device may be a mobile user endpoint device, such as a cellular smart phone, a gaming console, a laptop computer, a tablet computer, an autonomous vehicle, an extended reality (XR) device, an Internet of Things (IoT) device, or the like. The user endpoint device may connect to a mobile access network (e.g., a radio access network) which connects to a core network interface of a core network operated by a communications network service provider. In one example, the processing system may be part of the user endpoint device.

In one example, at least one software application may be executing on the user endpoint device. For instance, the user endpoint device may be executing a navigation application, a streaming music application, a stock trading application, and/or another type of application. Each application that is executing on the user endpoint device may generate a network traffic flow containing data to be exchanged with a device or service that is also connected to the core network.

In one example, the network traffic flow that is detected in step 204 may require handling by one or more specialized networks or services (e.g., DNS services, parental control services, secure browsing/cyber security services, video policy services, and/or other services). In one example, the network traffic flow that is detected in step 204 may require special handling to preserve the privacy (e.g., identity) of the user of the user endpoint device and/or the privacy of the data that is contained in the network traffic flow. The special handling to protect the privacy may be explicitly requested by the user (e.g., by the user taking an action to enable a VPN connection or other types of secure handling) or may be part of a default setting of a software application executing on the user endpoint device that generates the network traffic flow (e.g., a software application that transmits medical or financial data).

In step 206, the processing system may determine whether the bearer that the user endpoint device is currently utilizing to connect to the communications network is a cellular bearer. As discussed above, the user endpoint device may connect to the communications network using one or more different types of bearers or radio access technologies. For instance, the user endpoint device may be configured to connect to a WiFi access network whenever the user endpoint device is within range of a WiFi network and possesses access credentials for the WiFi network. As an example, the user endpoint device may connect to a public or unsecured WiFi network, or to a private or secured WiFi network for which the user device possesses the password or other credentials required for access. However, the user endpoint device may connect to a cellular network when the user endpoint device is not within range of a WiFi network to which the user endpoint device possesses access credentials.

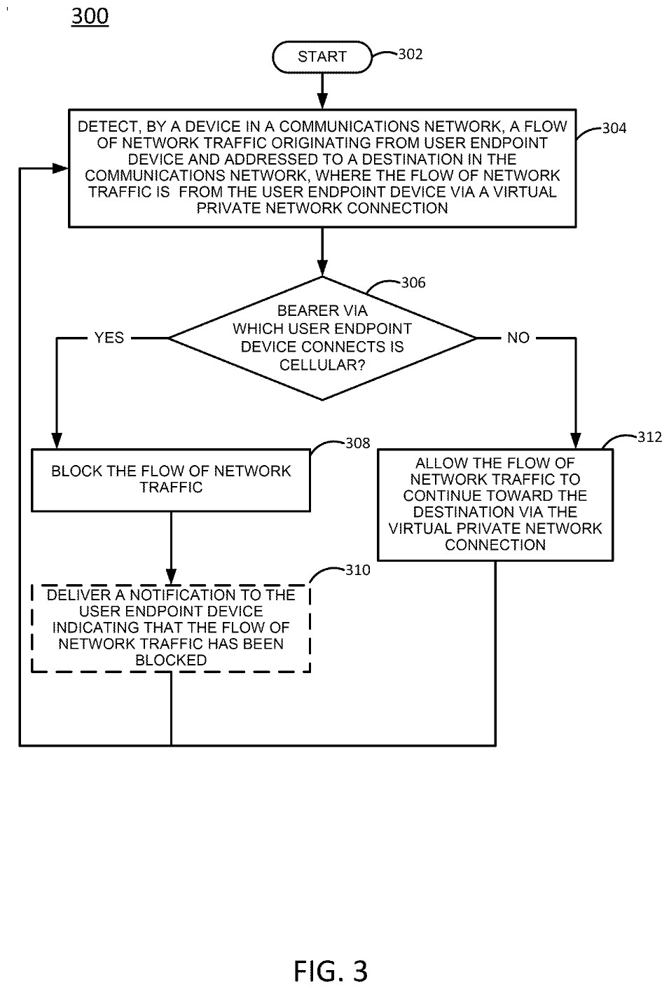

In one example (discussed in further detail below in connection with FIG. 3), the processing system may determine the type of bearer that is currently being used by the user endpoint device to connect to the communications network based on a notification from a device in the communications network. For instance, an edge server, a VPN proxy, or another device in the communications network may notify the processing system, in response to receiving the network traffic flow from the user endpoint device, that the network traffic flow has been blocked. The notification may indicate that the network traffic flow was blocked because the processing system attempted to route the network traffic flow via a VPN connection, while the user endpoint device is connected to the communications network via a cellular bearer. The notification may further provide suggestions for facilitating delivery of the network traffic flow to the destination. The suggestions may include switching to a non-cellular bearer and retrying the previous attempt to route the network traffic flow via the VPN connection or setting a switch so that the VPN connections may be bypassed while the user endpoint device is connected to the communications network via the cellular bearer.

If the processing system determines in step 206 that the endpoint device is currently connected to the communications network via a non-cellular bearer, then the method 200 may proceed to step 208. In step 208, the processing system may control a virtual private network client of the user endpoint device to route the network traffic flow to the destination over a virtual private network connection.

For instance, the processing system may control the VPN client to create an encrypted tunnel from the user endpoint device (e.g., from the VPN client or another client of the user endpoint device) to a virtual private network proxy, if such a tunnel has not already been established. In one example, the VPN client may utilize one or more tunneling protocols, such as IP in IP version 4 (IPv4)/IP version 6 (IPv6), general routing encapsulation (GRE), Encapsulating Security Payload (ESP), OpenVPN, secure socket tunneling protocol, Internet protocol security, Layer 2 tunneling protocol, and/or another protocol. The tunneling protocol(s) may be used to create the encrypted tunnel, or point-to-point connection. The endpoints of this encrypted tunnel may be the user endpoint device of which the VPN client is a part and the VPN proxy.

Once the encrypted tunnel has been established, the processing system may control the VPN client to route the network traffic flow to the virtual private network proxy via the encrypted tunnel for delivery to the destination. Thus, the processing system, in conjunction with the VPN client, may enable or create a VPN connection via which to route the network traffic flow. The network traffic flow will therefore be inaccessible to any internal services of a service provider internal network. As discussed above, these internal services may include DNS services, parental control services, secure browsing/cyber security services, video policy services, and/or other services.

If, however, the processing system determines in step 206 that the endpoint device is currently connected to the communications network via a cellular bearer, then the method 200 may proceed to step 210. In step 210, the processing system may control the virtual private network client of the user endpoint device to route the network traffic flow to the destination over existing network interfaces in a manner that bypasses the virtual private network connection.

In other words, the processing system may disable or block the VPN connection when the user endpoint device is connected to the communications network via a cellular bearer. In one example, the existing network interfaces may include core network interfaces and internal network interfaces of a service provider internal network. The destination to which the network traffic flow may be routed in step 210 may include, for example, one or more internal services of a service provider internal network, the Internet, or specialized network of another entity with which the communications service provider has arrangements (e.g., a cloud service provider network, a carrier hotel network, a peered content provider network, or the like).

Once the network traffic flow is routed appropriately (e.g., either over the VPN connection in accordance with step 208 or bypassing the VPN connection in accordance with step 210), the method 200 may return to step 204, and the processing system may proceed as described above to route subsequent network traffic flows appropriately, depending on the type of bearer via which the user endpoint device accesses the communications network. It should be noted that the type of bearer via which the user endpoint device accesses the communications network may change over time as the user endpoint devices moves into and/or out of the coverage area of different access networks. For instance, some user endpoint devices may be configured to connect to WiFi access networks by default whenever a WiFi access network is available, and may only connect to a cellular access network when no WiFi access network is available. As such, although one iteration of the method 200 may involve bypassing a VPN connection (e.g., bypassing step 210), a subsequent iteration of the method 200 by the same processing system may involve routing traffic via the VPN connection (e.g., step 208).

By configuring the VPN client of the user endpoint device with the ability to selectively enable or disable VPN connections based on the type of radio access network technology used to connect to the communications network, the privacy of network traffic flows can be preserved at all times, while also providing a service provider with the information needed to apply differentiated routing where needed. Thus, customer experience can also be preserved. Moreover, deploying the functionality that allows for the selective enablement or disablement of a VPN connection on the client side (e.g., in the VPN client), network capacity demands and the investments in network infrastructure needed to meet network capacity demands can be better managed, with minimal additional financial cost to the network operator.

In one example, the functionality that allows the user endpoint device to selectively enable or disable VPN connections based on radio access technology may be a functionality that a user of the user endpoint device opts into. For instance, as discussed in connection with FIG. 1, the functionality that allows the user endpoint device to selectively bypass VPN connections based on radio access technology may be implemented via a switch in the VPN client of the user endpoint device. The user of the user endpoint device may choose to set this switch to allow for the selective enablement and disablement of the VPN to be performed or to allow for VPN connections to be enabled regardless of the type of radio access technology being used.

FIG. 3 illustrates a flowchart of an example method 300 for selectively enabling virtual private network connections based on the radio access technology type of the bearer, in accordance with the present disclosure. In one example, steps, functions and/or operations of the method 300 may be performed by a device as illustrated in FIG. 1, e.g., an edge router 114 or VPN proxy 116 (or any one or more components thereof). In another example, the steps, functions, or operations of method 300 may be performed by a computing device or system 400, and/or a processing system 402 as described in connection with FIG. 4 below. For instance, the computing device 400 may represent an edge router in accordance with the present disclosure. For illustrative purposes, the method 300 is described in greater detail below in connection with an example performed by a processing system, such as processing system 402.

The method 300 begins in step 302. In step 304, the processing system may detect, by a device in a communications network, a network traffic flow originating from a user endpoint device and addressed to a destination in the communications network, where the network traffic flow is routed from the user endpoint device via a virtual private network connection.

In one example, the processing system may be part of an edge router or VPN proxy that is deployed in a service provider core network of the communications network. In one example, the user endpoint device may be a mobile user endpoint device, such as a cellular smart phone, a gaming console, a laptop computer, a tablet computer, an autonomous vehicle, an extended reality (XR) device, an Internet of Things (IoT) device, or the like. The user endpoint device may connect to a mobile access network (e.g., a radio access network) which connects to a core network interface of the core network. The network traffic flow may be associated with at least one software application that is executing on the user endpoint device, such as a navigation application, a streaming music application, a stock trading application, and/or another type of application. The destination may comprise one or more internal services of a service provider internal network, the Internet, or specialized network of another entity with which the communications service provider has arrangements (e.g., a cloud service provider network, a carrier hotel network, a peered content provider network, or the like).

In step 306, the processing system may determine whether the bearer that the user endpoint device is currently utilizing to connect to the communications network is a cellular bearer. As discussed above, the user endpoint device may connect to the communications network using one or more different types of bearers or radio access technologies. For instance, the user endpoint device may be configured to connect to a WiFi access network whenever the user endpoint device is within range of a WiFi network and possesses access credentials for the WiFi network. As an example, the user endpoint device may connect to a public or unsecured WiFi network, or to a private or secured WiFi network for which the user device possesses the password or other credentials required for access. However, the user endpoint device may connect to a cellular network when the user endpoint device is not within range of a WiFi network to which the user endpoint device possesses access credentials.

If the processing system concludes in step 306 that the bearer that the user endpoint device is currently utilizing to connect to the communications network is a cellular bearer, then the method 300 may proceed to step 308. In step 308, the processing system may block the network traffic flow.

In other words, the processing system may not allow the network traffic flow to proceed to the destination via the VPN connection when the user endpoint device is connected to the communications network via a cellular bearer.

In optional step 310 (illustrated in phantom), the processing system may further deliver a notification to the user endpoint device indicating that the network traffic flow has been blocked. In one example, the notification may additionally indicate the reason for the network traffic flow being blocked and/or suggestions for changes that can be made on the user endpoint device side to avoid future network traffic flows from being blocked. For instance, the notification may indicate that the communications network does not allow VPN connections over cellular radio access technology and may recommend that a user of the user endpoint device either change the settings of the user endpoint device (or the VPN client of the user endpoint device) to bypass VPN connections when connecting to the communications network via a cellular bearer or retry sending the network traffic flow once connected to the communications network via a non-cellular bearer.

Alternatively, if the processing system concludes in step 306 that the bearer that the user endpoint device is currently utilizing to connect to the communications network is not a cellular bearer, then the method 300 may proceed to step 312. In step 312, the processing system may allow the network traffic flow to continue toward the destination via the virtual private network connection. For instance, the network traffic flow may continue toward the destination via an encrypted tunnel, where the endpoints of the encrypted tunnel are the user endpoint device and the destination (which may comprise a VPN proxy in some examples).

Once the network traffic flow is routed appropriately (e.g., either over the VPN connection in accordance with step 312 or blocked in accordance with steps 308-310), the method 300 may return to step 304, and the processing system may proceed as described above to route subsequent network traffic flows appropriately, depending on the type of bearer via which the user endpoint device accesses the communications network. It should be noted that the type of bearer via which the user endpoint device accesses the communications network may change over time as the user endpoint devices moves into and/or out of the coverage area of different access networks. For instance, some user endpoint devices may be configured to connect to WiFi access networks by default whenever a WiFi access network is available, and may only connect to a cellular access network when no WiFi access network is available. As such, although one iteration of the method 300 may involve blocking a network traffic flow over a VPN connection (e.g., in accordance with steps 308-310), a subsequent iteration of the method 300 involving a subsequent network traffic flow originating from the same user endpoint device may involve allowing routing of the subsequent network traffic flow via the VPN connection (e.g., in accordance with step 312).

It should be noted that the method 200 and the method 300 may be expanded to include additional steps or may be modified to include additional operations with respect to the steps outlined above. In addition, although not specifically specified, one or more steps, functions, or operations of the method 200 and the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for selectively enabling virtual private network connections based on the radio access technology type of the bearer, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 or the method 300 as discussed above is implemented in a distributed or parallel manner for a particular illustrative example, i.e., the steps of the above method 200 or the method 300 or the entire method 200 or method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200 or method 300. In one example, instructions and data for the present module or process 405 for selectively enabling virtual private network connections based on the radio access technology type of the bearer (e.g., a software program comprising computer-executable instructions) can be loaded into memory 404 and executed by hardware processor element 402 to implement the steps, functions, or operations as discussed above in connection with the illustrative method 200 or method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for selectively enabling virtual private network connections based on the radio access technology type of the bearer (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system of a user endpoint device in a communications network, a network traffic flow to be securely delivered from the user endpoint device to a destination in the communications network;
determining, by the processing system, that a bearer that the user endpoint device is currently utilizing to connect to the communications network is a cellular bearer; and
controlling, by the processing system in response to the determining, a virtual private network client of the user endpoint device to route the network traffic flow to the destination over existing network interfaces in a manner that bypasses a virtual private network connection of the user endpoint device.

2. The method of claim 1, wherein the user endpoint device is a mobile user endpoint device.

3. The method of claim 1, wherein the destination is at least one of: an internal service of a service provider internal network, an internal service of an internet, or an internal service of a specialized network of an entity with which an operator of the communications network has an arrangement.

4. The method of claim 1, wherein the network traffic flow requires handling by at least one of: a domain name system service, a parental control service, a secure browsing service, a cyber security service, or a video policy service.

5. The method of claim 1, wherein the existing network interfaces include at least one of: a core network interface of a core network of the communications network or an internal network interface of a service provider internal network of the communications network.

6. The method of claim 1, wherein the controlling is performed in response to a setting of a switch in the virtual private network client that causes the virtual private network connection to be bypassed whenever the user endpoint device is utilizing the cellular bearer to connect to the communications network.

7. The method of claim 6, wherein the setting of the switch is controllable by a user of the user endpoint device.

8. The method of claim 1, further comprising:
detecting, by the processing system, a subsequent network traffic flow after controlling the virtual private network client of the user endpoint device to route the network traffic flow to the destination over the existing network interfaces in the manner that bypasses the virtual private network connection of the user endpoint device.

9. The method of claim 8, further comprising:
determining, by the processing system, that the bearer that the user endpoint device is currently utilizing to connect to the communications network is a non-cellular bearer; and
controlling, by the processing system in response to the determining that the bearer that the user endpoint device is currently utilizing to connect to the communications network is the non-cellular bearer, the virtual private network client of the user endpoint device to route the subsequent network traffic flow to the destination via the virtual private network connection of the user endpoint device.

10. The method of claim 1, wherein the determining is performed in accordance with a notification received from a device in the communications network.

11. The method of claim 10, wherein the notification notifies the processing system that a previous attempt to route the network traffic flow via the virtual private network connection of the user endpoint device has been blocked because the bearer that the user endpoint device is currently utilizing to connect to the communications network is the cellular bearer.

12. The method of claim 11, wherein the notification further suggests that the processing system set a switch in the virtual private network client to allow the virtual private network connection of the user endpoint device to be bypassed while the user endpoint device is using the cellular bearer to connect to the communications system.

13. The method of claim 12, wherein the notification further suggests that the user endpoint device utilizes a non-cellular bearer to connect to the communications system and re-attempt the previous attempt to route the network traffic flow via the virtual private network connection.

14. A non-transitory computer-readable medium storing instructions which, when executed by a processing system of a user endpoint device in a communications network, the processing system including at least one processor, cause the processing system to perform operations, the operations comprising:
detecting a network traffic flow to be securely delivered from the user endpoint device to a destination in the communications network;
determining that a bearer that the user endpoint device is currently utilizing to connect to the communications network is a cellular bearer; and
controlling, in response to the determining, a virtual private network client of the user endpoint device to route the network traffic flow to the destination over existing network interfaces in a manner that bypasses a virtual private network connection of the user endpoint device.

15. The non-transitory computer-readable medium of claim 14, wherein the operations further comprise:
detecting a subsequent network traffic flow after controlling the virtual private network client of the user endpoint device to route the network traffic flow to the destination over the existing network interfaces in the manner that bypasses the virtual private network connection of the user endpoint device.

16. The non-transitory computer-readable medium of claim 15, wherein the operations further comprise:
determining that the bearer that the user endpoint device is currently utilizing to connect to the communications network is a non-cellular bearer; and
controlling, in response to the determining that the bearer that the user endpoint device is currently utilizing to connect to the communications network is the non-cellular bearer, the virtual private network client of the user endpoint device to route the subsequent network traffic flow to the destination via the virtual private network connection of the user endpoint device.

17. The non-transitory computer-readable medium of claim 14, wherein the determining is performed in accordance with a notification received from a device in the communications network, and wherein the notification notifies the processing system that a previous attempt to route the network traffic flow via the virtual private network connection of the user endpoint device has been blocked because the bearer that the user endpoint device is currently utilizing to connect to the communications network is the cellular bearer.

18. A user endpoint device comprising:
a processing system including at least one processor; and
a non-transitory computer-readable medium storing instructions which, when executed by the processing system, cause the processing system to perform operations, the operations comprising:
detecting a network traffic flow to be securely delivered from the user endpoint device in a communications network to a destination in the communications network;
determining that a bearer that the user endpoint device is currently utilizing to connect to the communications network is a cellular bearer; and
controlling, in response to the determining, a virtual private network client of the user endpoint device to route the network traffic flow to the destination over existing network interfaces in a manner that bypasses a virtual private network connection of the user endpoint device.

19. The user endpoint device of claim 18, wherein the operations further comprise:
detecting a subsequent network traffic flow after controlling the virtual private network client of the user endpoint device to route the network traffic flow to the destination over the existing network interfaces in the manner that bypasses the virtual private network connection of the user endpoint device.

20. The user endpoint device of claim 19, wherein the operations further comprise:
determining that the bearer that the user endpoint device is currently utilizing to connect to the communications network is a non-cellular bearer; and
controlling, in response to the determining that the bearer that the user endpoint device is currently utilizing to connect to the communications network is a non-cellular bearer, the virtual private network client of the user endpoint device to route the subsequent network traffic flow to the destination via the virtual private network connection of the user endpoint device.
